(19) United States
(12) Patent Application Publication
(10) Pub. No.: US 2007/0024892 A1
(43) Pub. Date: Feb. 1, 2007

(54) Security printing control method and apparatus, and printing system thereof

(75) Inventor: Young-Taek Cho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/487,985

(22) Filed: Jul. 18, 2006

(30) Foreign Application Priority Data
Jul. 28, 2005 (KR) 10-2005-0069118

(51) Int. Cl. G06K 15/00

(52) U.S. Cl. 358/1.14; 358/1.15

(57) ABSTRACT

A security printing control method and apparatus using the location of a user, and a printing system thereof are provided. The printing system allows a print operation to be performed only when the user is in a print allowance area around a printing apparatus. The security printing control method includes detecting information regarding a location of a user, determining whether or not the user is in a print allowance area on the basis of the detected location information, and allowing a corresponding document to be printed if the user is in the print allowance area. In the security printing control method and apparatus and the security printing system thereof, when documents requiring security classifications are printed, by allowing a print operation to be performed only when a user is in a print allowance area around a printing apparatus, it is possible to prevent the documents requiring the security classifications from being disclosed to other people when the user is out of the print allowance area, thereby enhancing the security of document printing.

### CROSS-REFERENCE TO RELATED APPLICATIONS

This application claims the benefit under 35 U.S.C. §119(a) of a Korean patent application No. 10-2005-0069118, filed on Jul. 28, 2005, in the Korean Intellectual Property Office, the entire disclosure of which is hereby incorporated by reference.

### BACKGROUND OF THE INVENTION

1. Field of the Invention

The present invention relates to a printing control method and apparatus. More particularly, the present invention relates to a security printing control method and apparatus for preventing documents requiring security classifications from being disclosed to other people, and a security printing system thereof.

2. Description of the Related Art

A printing apparatus has a function of converting a document, which is written out by a user through an application program, into coded data and outputting the data on a sheet, in other words, into a format, which can be interpreted by a user. Recently, security functions for securing print documents have been added to printing apparatuses.

FIG. 1 is a block diagram of a conventional security printing system. Referring to FIG. 1, a host computer 100 outputs document data to be printed and security information, for example, an ID and a password of a user having print authority for the document, for the document to a printing apparatus 110 by using an application program. The printing apparatus 110 temporally stores the document data and the security information in a memory (not shown), and holds a print job in a print queue.

In order to perform the print job, the user must obtain security authority from the printing apparatus 110, for example, must input his or her ID and password. The printing apparatus 110 compares the ID and password input by the user with an ID and password stored in the memory (not shown), and prints the document if the IDs and passwords are identical.

When security printing is performed by using the conventional technique as described above, if a user obtains security authority to start a print job and then leaves a print document around the printing apparatus, the print document requiring security classification may be disclosed to other people.

Accordingly, there is a need for an improved apparatus and method for controlling printing of a document.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a security printing control method and apparatus, which allow a print job to be performed if a user is in a print allowance area around a print apparatus when security printing is performed, and a security print system thereof.

According to an exemplary aspect of the present invention, a security printing control method of controlling printing of a document is provided. The method comprises detecting information regarding a location of a user, determining whether or not the user is in a print allowance area on the basis of the detected location information, and allowing the document to be printed if the user is in the print allowance area.

The detection of the information regarding the location of the user is performed by using a Radio Frequency IDentification (RFID) system. The determining whether or not the user is in the print allowance area comprises determining that the user is in the print allowance area if a distance between the user and a printing apparatus is less than a predetermined distance.

The security printing control method further comprises stopping the printing of the document if the user is not in the print allowance area. The security printing control method further comprises canceling the printing job of the document if the user does not enter the print allowance area in a predetermined time.

The security printing control method further comprises generating and providing an error message containing information regarding the canceling of the printing of the document, to the user. The security printing control method further comprises, if the user is not in the print allowance area before the document is printed, changing a priority of a print job corresponding to the document to a lower priority in a print queue.

According to another exemplary aspect of the present invention, a security printing control apparatus for controlling printing of a document is provided. The apparatus comprises a location detector for detecting information regarding a location of a user, an area check unit for checking whether or not the user is in a print allowance area using the detected location information, and a control signal generator for generating a signal for printing the document if the user is in the print allowance area.

The location detector receives a signal from a Radio Frequency IDentification (RFID) tag of the user and detects the information regarding the location of the user from the received signal. The area check unit determines that the user is in the print allowance area if a distance between the user and a printing apparatus is less than a predetermined distance.

The control signal generator generates a signal for stopping the printing of the document if the user is not in the print allowance area. The control signal generator generates a signal for canceling the printing job of the document if the user does not enter the print allowance area in a predetermined time. The security printing control apparatus further comprises a message generator for generating and providing an error message containing information regarding the canceling of the printing job of the document, to the user.

The control signal generator generates a signal for changing a priority of the document to a lower priority in a print queue, if it is determined that the user is not in the print allowance area before the document is printed.

According to another aspect of the present invention, a security printing system including a server and a print apparatus is provided. The server determines whether or not to perform a print job requested from the print apparatus according to whether or not a user is in a print allowance area, and generates a signal corresponding to the determination result. The print apparatus performs the print job if the signal for allowing the print job is received from the server.

The security printing system comprises a location detector for detecting information regarding a location of the user; an area check unit for checking whether or not the user is in the print allowance area using the detected location information; and a control signal generator for generating a signal for printing a corresponding document if the user is in the print allowance area.

The location detector receives a signal from a Radio Frequency Identification (RFID) tag of the user and detects the information regarding the location of the user from the received signal. The area check unit determines that the user is in the print allowance area if a distance between the user and the print apparatus is less than a predetermined distance.

According to another exemplary aspect of the present invention, a computer-readable recording medium having embodied thereon a computer program for executing the security printing control method is also provided.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a conventional security printing system;

FIG. 2 is a flowchart illustrating a security printing control method using the location of a user, according to an exemplary embodiment of the present invention;

FIG. 3 is a block diagram illustrating a security printing control apparatus using the location of a user, according to an exemplary embodiment of the present invention; and

FIG. 4 is a block diagram illustrating a security printing system using the location of a user, according to an exemplary embodiment of the present invention.

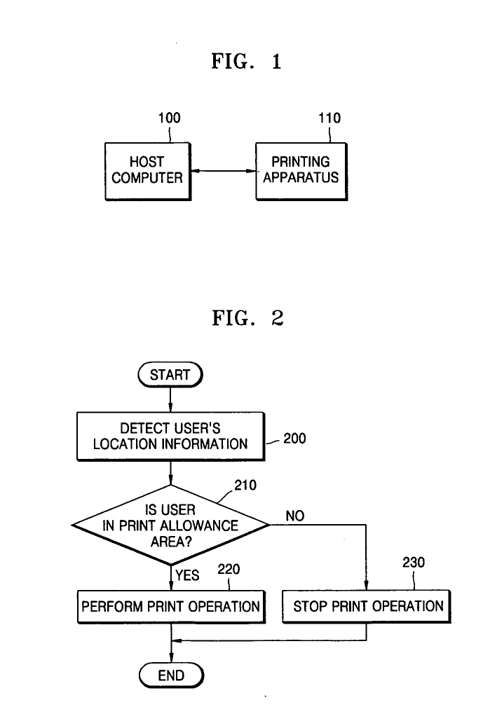

Throughout the drawings, like reference numerals will be understood to refer to like parts, components and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

FIG. 2 is a flowchart illustrating a security printing control method using the location of a user according to an exemplary embodiment of the present invention.

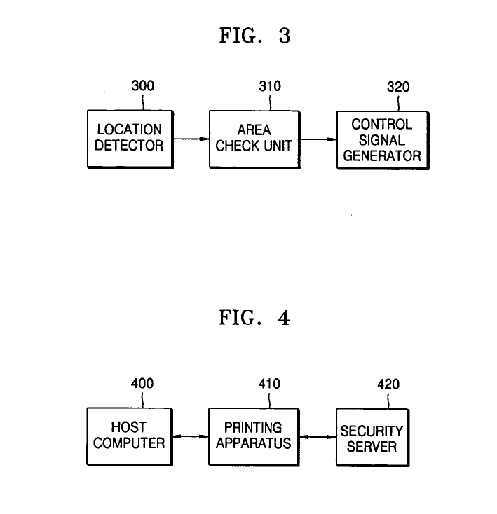

Hereinafter, the security printing control method illustrated in FIG. 2 will be described with reference to a security printing control apparatus according to an exemplary embodiment of the present invention illustrated in FIG. 3. The security printing control apparatus comprises a location detector 300, an area check unit 310, and a control signal generator 320.

The location detector 300 detects information regarding a location of a current user at step 200. The information regarding the location of the user may comprise the location of the user and a location of a printing apparatus. The location detector 300 detects the location information of the user by using, for example, a Radio Frequency IDentification (RFID) system.

The RFID system is a non-contact identification system for transmitting and processing information of various products and peripheral environment information using a wireless frequency by attaching a small-sized chip to the products. The RFID system comprises a reader having read and interpretation functions, a RF ID tag for storing information, an operator software, a network, and the like. The reader receives and transmits signals in a non-contact state with the RF tag and reads or interprets information stored in the RF tag.

The user possesses a card to which the RF tag is attached, wherein the RF tag may store information related to the user, for example, information related to a security ID, a password, security authority, and the like of the user. At least one RFID reader (not shown) is installed around the printing apparatus. Each RFID reader (not shown) receives and transmits the RF tag and signals to receive user information stored in the RF tag, thus determining whether or not the user is in a predetermined area in which the RFID reader is installed.

The location detector 300 receives information indicating whether or not the user is in the predetermined area in which the RFID reader is installed, from the at least one RFID reader, and detects a current location of the user. Also, the location of the printing apparatus can be detected in the same manner described above, by attaching an RF tag to the printing apparatus.

The area check unit 310 receives the information regarding the user's location from the location detector 300, and determines whether or not the user is in a predetermined print allowance area around the printing apparatus at step 210. The area check unit 300 calculates a distance between the current location of the user and a current location of the printing apparatus, thus determining that the user is not in a print allowance area if the calculated distance is greater than a predetermined allowance distance, and determining that the user is in the print allowance area if the calculated distance is less than the predetermined allowance distance.

The control signal generator 320 receives a signal containing information indicating whether or not the user is in the print allowance area, from the area check unit 310, generates a print allowance command signal for performing a requested document print job if the user is in the print allowance area at step 220, and generates a print standby command signal for stopping the requested document print job if the user is not in the print allowance area at step 230.

The security printing control method periodically performs steps 200 through 230 from when a print job is requested for the printing apparatus to when the printing job is complete. If the user is not in the print allowance area before a requested document is printed, the control signal generator 320 generates a signal for changing a priority of the print job corresponding to the request document to a lower priority in a print queue which is the order information of print jobs which are temporally stored in the memory of the print apparatus and hold in an order.

Also, if the user does not enter the print allowance area in a predetermined first standby time after a print job is requested, the control signal generator 320 generates a signal for erasing data of the document which is temporally stored in the memory of the print apparatus to thus cancel the corresponding print job. If the print job is cancelled, an error message containing information, such as the cancellation reason of the print job, the name of the cancelled document, and the like, is created and displayed on a monitor screen of a host computer or printed on a sheet by the printing apparatus. Alternatively, the error message can be provided to the user through an E-mail, a Short Message Service (SMS), a voice message, and the like.

If the user is outside the print allowance area while a print job is performed, the control signal generator 320 generates a print standby command signal. After the print job is stopped in response to the print standby command signal, if the user does not enter the print allowance area in a predetermined second standby time, the control signal generator 320 generates a signal for canceling the print job and generates the error message.

FIG. 4 is a block diagram illustrating a security printing system using the location of a user, according to an exemplary embodiment of the present invention. Referring to FIG. 4, the security printing system comprises a host computer 400, a printing apparatus 410, and a security server 420.

The host computer 400 outputs document data to be printed and security information regarding the document, for example, an ID and a password of a user having print authority over the document, to the printing apparatus 410, using an application program. The printing apparatus 410 temporally stores the received document data and the security information in a memory (not shown), holds a print job in a print queue, and generates and outputs a signal for requesting information indicating whether or not to perform the print job, to the security server 420.

The security server 420, which comprises the security control apparatus as described above, detects the location of the user; determines whether or not the user is in a print allowance area; and generates a print control signal according to whether or not the user is in the print allowance area. The security server 420 detects the location of the user using the user-related information received through the printing apparatus 410.

The security server 420 outputs the print control signal, for example, a print allowance signal or a print standby signal to the printing apparatus 410, in response to a request from the printing apparatus 410. The printing apparatus 410 performs the corresponding print job if receiving the print allowance signal from the security server 420, and stops the print job if receiving the print standby signal from the security server 420.

The present invention can also be embodied as computer readable code on a computer readable recording medium. The computer readable recording medium is any data storage device that can store data which can be thereafter read by a computer system. Examples of the computer readable recording medium comprise read-only memory (ROM), random-access memory (RAM), CD-ROMs, magnetic tapes, floppy disks, optical data storage devices and carrier waves, for example, transmission through the Internet.

As described above, in a security printing control method and apparatus and a security printing system thereof, according to the present invention, by allowing a print operation to be performed only when a user is in a print allowance area around a print apparatus, it is possible to prevent documents requiring security classifications from being disclosed to other people when the user is outside the print allowance area, thereby enhancing the security of document printing.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. A security printing control method of controlling printing of a document, comprising:
detecting a location of a user;
determining whether the user is in a print allowance area based on the detected location; and
allowing the document to be printed if the user is in the print allowance area.

2. The security printing control method of claim 1, wherein the detection comprises detection of the location by a Radio Frequency IDentification (RFID) system.

3. The security printing control method of claim 1, wherein the determining comprises determining that the user is in the print allowance area if the location of the user is less than a distance value from a printing apparatus.

4. The security printing control method of claim 1, further comprising stopping the printing of the document if the user is not in the print allowance area.

5. The security printing control method of claim 1, further comprising canceling the printing job of the document if the user does not enter the print allowance area in a time period.

6. The security printing control method of claim 5, further comprising generating an error message comprising information regarding the canceling of the printing of the document, and providing the error message to the user.

7. The security printing control method of claim 1, further comprising, if the user is not in the print allowance area before the document is printed, changing a priority of a print job corresponding to the document to a lower priority in a print queue.

8. A security printing control apparatus for controlling printing of a document, the apparatus comprising:
a location detector for detecting a location of a user;
an area check unit for checking whether the user is in a print allowance area using the detected location information; and
a control signal generator for generating a signal for printing the document if the user is in the print allowance area.

9. The security printing control apparatus of claim 8, wherein the location detector receives a signal from a Radio Frequency IDentification (RFID) tag of the user and detects the location of the user based on the received signal.

10. The security printing control apparatus of claim 8, wherein the area check unit determines that the user is in the print allowance area if the location of the user is less than a distance value from a printing apparatus.

11. The security printing control apparatus of claim 8, wherein the control signal generator generates a signal for stopping the printing of the document if the user is not in the print allowance area.

12. The security printing control apparatus of claim 8, wherein the control signal generator generates a signal for canceling the printing job of the document if the user does not enter the print allowance area in a time period.

13. The security printing control apparatus of claim 12, further comprising a message generator for generating an error message comprising information regarding the canceling of the printing job of the document, and providing the error message to the user.

14. The security printing control apparatus of claim 8, wherein the control signal generator generates a signal for changing a priority of the document to a lower priority in a print queue, if it is determined that the user is not in the print allowance area before the document is printed.

15. A security printing system comprising:
a server for determining whether to perform a print job requested from a print apparatus according to whether a user is in a print allowance area; and
a signal generator for generating a signal corresponding to the determination result;
wherein, the print apparatus performs the print job if a signal allowing the print job is received from the signal generator.

16. A security printing system comprising:
a location detector for detecting a location of the user;
an area check unit for checking whether the user is in the print allowance area using the detected location; and
a control signal generator for generating a signal for printing a corresponding document if the user is in the print allowance area.

17. The security printing system of claim 16, wherein the location detector receives a signal from a Radio Frequency Identification (RFID) tag of the user and detects the location of the user based on the received signal.

18. The security printing system of claim 16, wherein the area check unit determines that the user is in the print allowance area if the location of the user is less than a distance value from the print apparatus.

19. Program code embodied on a computer-readable recording medium for executing the security printing control, the program code comprises:
a first set of instructions for detecting a location of a user;
a second set of instructions for determining whether the user is in a print allowance area on the basis of the detected location; and
a third set of instructions for allowing the document to be printed if the user is in the print allowance area.
